(19) United States
(12) Patent Application Publication
(10) Pub. No.: US 2013/0207950 A1
(43) Pub. Date: Aug. 15, 2013

(54) IMAGE DISPLAY APPARATUS

(71) Applicants: Fumio HARUNA, Fujisawa (JP); Tomoki Kobori, Kamakura (JP)

(72) Inventors: Fumio HARUNA, Fujisawa (JP); Tomoki Kobori, Kamakura (JP)

(21) Appl. No.: 13/604,799

(22) Filed: Sep. 6, 2012

(30) Foreign Application Priority Data
Feb. 9, 2012 (JP) 2012-025714

(51) Int. Cl. G09G 5/10

(52) U.S. Cl. 345/207

(57) ABSTRACT

In an image display apparatus which projects and displays an image by scanning emitted light from light sources by a reflective mirror, a correction unit calculates a threshold value and a slope efficiency of a light amount vs. current characteristic of each of the plurality of light sources, from a first light amount value obtained by measuring a light amount when an input image signal agrees with a first reference signal level and a second light amount value obtained by measuring a light amount when the input image signal agrees with a second reference signal level; and corrects, when a calculation result of the threshold value and the slope efficiency varied after a predetermined time, a threshold current and also make a correction so that a light amount ratio of the light sources becomes the same as an initial value of a slope efficiency ratio.

### INCORPORATION BY REFERENCE

The present application claims priority from Japanese application JP2012-025714 filed on Feb. 9, 2012, the content of which is hereby incorporated by reference into this application.

### BACKGROUND OF THE INVENTION

The present invention relates to image display apparatuses using MEMS (Micro Electro Mechanical Systems) and the like.

Recently, a compact projection-type projector using MEMS and semiconductor laser light sources has become popular. For example, JP-A-2006-343397 discloses a projector that projects an image by modulating a laser light source while horizontally and vertically scanning a biaxial MEMS mirror.

However, the light amount vs. forward current characteristic of a semiconductor laser for use in a compact projection-type projector varies with temperature, so this projector has a problem that the white balance of a display screen varies.

A method of compensating for the temperature variation of a semiconductor laser is disclosed in JP-A-2009-15125.

### SUMMARY OF THE INVENTION

However, the technique disclosed in JP-A-2009-15125 does not take into account an image display apparatus like a projection-type projector, so it has a problem that the white balance cannot be adjusted.

The present invention has been made in view of the above circumstances and provides a laser projection-type projector capable of maintaining the white balance constant even if temperature varies.

In order to solve the aforesaid problem of the related art, an image display apparatus according to this invention is configured to include:

a plurality of light sources;

a light source drive unit configured to drive the plurality of light sources;

a reflective mirror that reflects emitted light from the light source and projects the reflected light onto an object;

a mirror driving unit configured to drive the reflective mirror;

an image processing unit configured to perform signal processing on an input image signal; and

a sensor for measuring a light amount of each of the plurality of light sources, the image display apparatus projecting and displaying an image by scanning the emitted light from the plurality of light sources by means of the reflective mirror, the image display apparatus further comprising a correction unit configured to:

set a first reference signal level and a second reference signal level;

calculate a threshold value and a slope efficiency of a light amount vs. current characteristic of each of the plurality of light sources, from a first light amount value obtained by measuring a light amount when the input image signal agrees with the first reference signal level by means of the sensor and a second light amount value obtained by measuring a light amount when the input image signal agrees with the second reference signal level by means of the sensor;

store initial values of the threshold value and the slope efficiency; and

correct, when a calculation result of the threshold value and the slope efficiency varied after a predetermined time, a threshold current and also make a correction so that a light amount ratio of the plurality of light sources becomes the same as an initial value of a slope efficiency ratio.

According to the present invention, a laser projection-type projector can be provided wherein the white balance will not vary with temperature.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory view showing the basic configuration of a projection-type projector of an embodiment of the present invention.

FIG. 2 is an explanatory view showing a light amount vs. forward current characteristic of a monochromatic light source of the embodiment.

FIG. 3 is an explanatory view showing the internal configuration of an image processing unit 2 of the embodiment.

FIG. 4A is an explanatory view showing the light amount vs. forward current characteristics of RGB light sources of the embodiment.

FIG. 4B is another explanatory view showing the light amount vs. forward current characteristics of the RGB light sources of the embodiment.

FIG. 5 is an explanatory view showing the light amount vs. forward current characteristic of a monochromatic light source of the embodiment.

FIG. 6 is a flowchart showing the operation of the image processing unit 2 of the embodiment.

FIG. 7 is a timing chart showing the operation of the image processing unit 2 of the embodiment.

FIG. 8 is a timing chart showing the operation of the image processing unit 2 of Embodiment 2.

FIG. 9 is a timing chart showing operation of the image processing unit 2 of Embodiment 3.

FIG. 10 is a timing chart showing the operation of the image processing unit 2 of Embodiment 4.

### DETAILED DESCRIPTION OF THE EMBODIMENTS

Hereinafter, the embodiments of the present invention will be described in detail in accordance with the accompanying drawings. In all the drawings for illustrating the embodiments, the same symbol is attached to the same member, as a principle, and the repeated explanation thereof is omitted.

### Embodiment 1

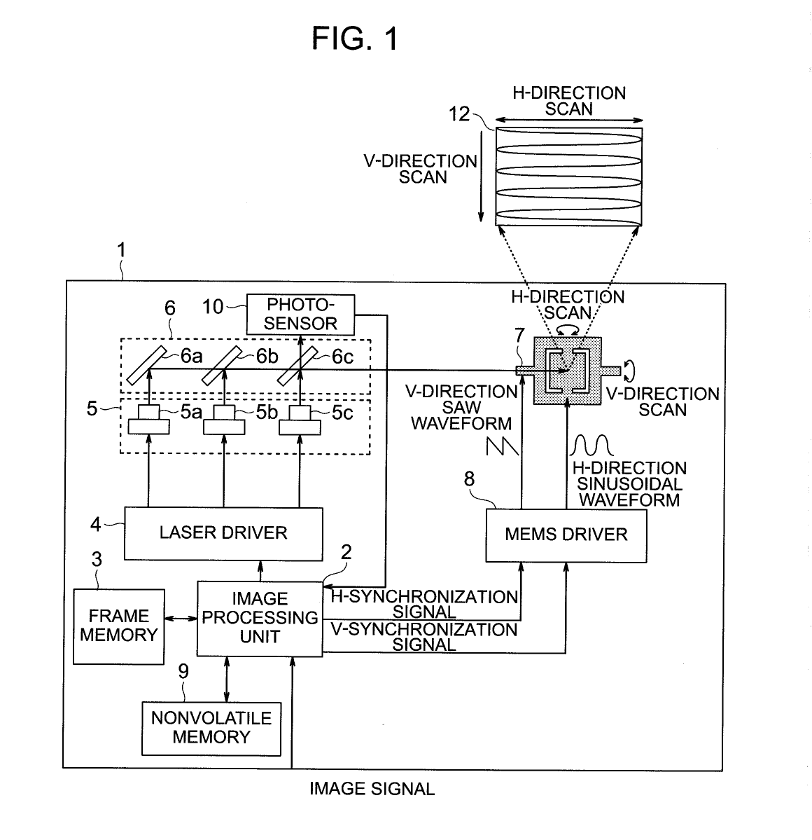

A configuration example of a projection type projector using MEMS in an embodiment of the present invention is shown in FIG. 1. A projection-type projector 1 comprises an image processing unit 2, a frame memory 3, a laser driver 4, a laser 5, a reflective mirror 6, a MEMS 7, a MEMS driver 8, a nonvolatile memory 9, a photosensor 10, a temperature sensor (not shown), and a display image 12. The temperature sensor may not be used in this embodiment. The image processing unit 2 generates an image signal, which is obtained by adding various corrections to an image signal input from the outside, and also generates a horizontal synchronizing signal and a vertical synchronizing signal in synchronization with this signal. Moreover, it also controls an image signal directed to the laser driver 4 in accordance with a light amount obtained from the photosensor 10 and adjusts the same so that the white balance becomes constant. The details thereof will be described later. Here, the various corrections imply carrying out correction of the image distortion due to scanning of the MEMS 7 and the like. Specifically, the image distortion varies with the relative angle between the projector unit 1 and a plane of projection, and is caused by an optical axial deviation between the laser 5 and the MEMS 7, and the like. The laser driver 4 receives an image signal output from the image processing unit 2, and modulates the laser 5 in accordance with this signal. For example, three lasers 5 (5a, 5b, 5c) are used for RGB colors, and modulation is carried out for each of RGB colors of the image signal, and the laser beams of RGB colors are output. The laser beams of RGB colors are combined by the reflective mirror 6. Note that, for the reflective mirror 6, a special optical element reflecting a specific wavelength and transmitting the other wavelengths is used. The reflective mirror 6 is usually called the dichroic mirror.

For example, a reflective mirror 6a has the characteristic of reflecting all the laser beams, a reflective mirror 6b has the characteristic of transmitting the laser beam of the laser 5a and reflecting the laser beam of the laser beam of the laser 5b, and the reflective mirror 6c has the characteristic of transmitting the laser beams of the lasers 5a and 5b and reflecting the laser beam of the laser 5c. Thus, the laser beams of RGB colors can be combined into one laser beam. The combined laser beam is incident upon the MEMS 7. In the MEMS 7, one element has a rotating mechanism with two shafts, wherein a mirror unit in the center can be horizontally and vertically vibrated with the two shafts. The vibration control of the mirror is carried out by the MEMS driver 8.

The MEMS driver 8 generates a sinusoidal waveform in synchronization with the horizontal synchronizing signal from the image processing unit 2, and generates a saw waveform in synchronization with the vertical synchronizing signal, thereby driving the MEMS 7. The MEMS 7, upon receipt of the sinusoidal waveform, exhibits a sinusoidal movement in a horizontal direction, and at the same time, upon receipt of the saw waveform, exhibits a uniform movement in one of the vertical directions. Thus, the laser beam is scanned along a locus as shown by the display image 12 of FIG. 1, and this scan being in synchronization with the modulation operation of the laser driver 4 allows an input image to be projected.

Here, the photosensor 10 is arranged so as to detect leakage light of the laser beams of RGB colors that are combined by the reflective mirror 6. That is, the photosensor 10 is arranged on the opposite side of the reflective mirror 6c of the laser 5c. The reflective mirror 6c has the characteristic of transmitting the laser beams of the lasers 5a and 5b and reflecting the laser beam of the laser 5c, but cannot have the characteristic of 100% transmission or 100% reflection, and usually reflects several % of the laser beams (lasers 5a and 5b) or transmits several % of the laser beam (laser 5c). Accordingly, by arranging the photosensor 10 at the position in FIG. 1, several % of the laser beam of the laser 5a can transmit and also several % of the laser beams of the lasers 5a and 5b can be reflected, thereby allowing several % of the laser beams of the lasers 5a and 5b to enter the photosensor 10. The photosensor 10 measures the light amount of each incident laser beam, and outputs the result to the image processing unit 2.

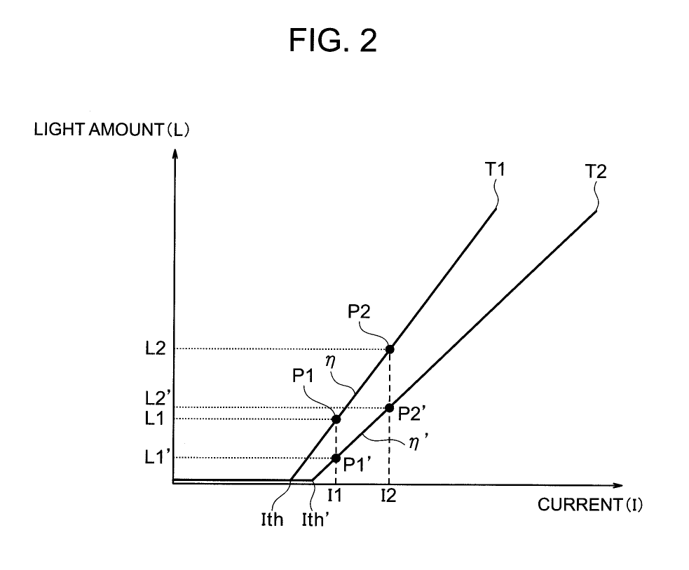

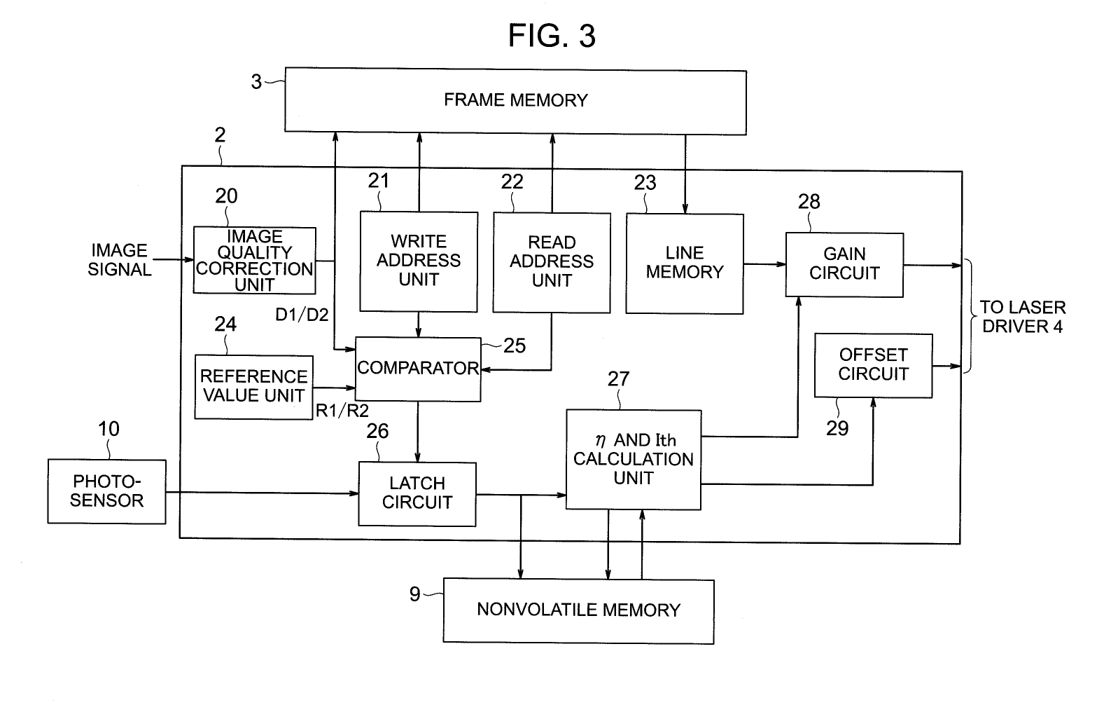

Next, an image signal correction process by the image processing unit 2 is described using FIG. 2 and FIG. 3. FIG. 2 is a view showing the operation that the light amount vs. forward current characteristic of a laser varies with temperature, and FIG. 3 is a view showing the internal configuration of the image processing unit 2.

In a semiconductor laser, the light amount vs. forward current characteristic thereof varies with temperature as sown in FIG. 2. In FIG. 2, there are two temperature conditions T1 and T2 where T1<T2. As shown in FIG. 2, generally, as temperature increases, a threshold current (Ith1) of a forward current increases and a slope efficiency (η) decreases. Accordingly, even if the same current is fed, as temperature varies the light amount will also vary. Furthermore, the variations of the threshold value and slope efficiency differ depending on RGB colors and therefore if temperature varies, the white balance will also vary. Then, the light amounts L1 and L2 when the currents are I1 and I2 at T1 are measured, and from two points (P1 and P2), a straight line is approximated. Then, the slope efficiency η of this approximation straight line and a point Ith, where the approximation straight line crosses the X-axis and where the light amount becomes zero, are calculated. Similarly, a slope efficiency and a point Ith′ at T2 are calculated. These and Ith, Ith′ vary with temperature. Then, and Ith in the first initial state are stored in advance, and a deviation amount of the white balance is predicted in accordance with the variations of and Ith′ after temperature varies, and the corrections of an image signal and a laser driving current are carried out.

FIG. 3 is the internal configuration of the image processing unit 2 for carrying out the corrections of an image signal and a laser driving current. In the image processing unit 2, an image quality correction unit 20 first carries out general image quality correction processings, such as contrast adjustment, gamma correction, and image distortion correction, on an input image signal, and this result is once stored into the frame memory 3. In writing the corrected image data to the frame memory 3, it is written at a memory coordinate corresponding to an address which the write address unit 21 generates.

The image data written to the frame memory 3 is read in an order of addresses specified by a read address unit 22 corresponding to the scanning of the mirror. Moreover, the image data in the frame memory 3 is delayed by one frame with respect to the input image data and then read.

The read image data is once input to the line memory 23. The line memory 23 captures image signals for one horizontal period, and sequentially reads the image data in the next horizontal period. The reason why the image data is relayed once by the line memory 23 is as follows. Usually, a read clock frequency of the frame memory 3 may be different from a clock frequency when image data is transmitted to the laser driver 4 side. Therefore, the image signals for one horizontal period are once captured by the line memory 23 at the read clock frequency of the frame memory 3, and thereafter the image signals are read from the line memory 23 at the transmission clock frequency of the image data. If the read clock frequency of the frame memory 3 agrees with the transmission clock frequency of the image data, the line memory 23 is unnecessary. The image data read from the line memory 23 is supplied to the laser driver 4 through the gain circuit 28. In the gain circuit 28, a coefficient is multiplied by the slope efficiency (η) to be described later. The multiplication coefficient of the gain circuit 28 is set to be equal to or less than 1, so that the output image data tends to be smaller than input image data. Note that, the multiplication coefficient may be set to be equal to or greater than 1, but in this case, the image data will overflow (if the image data is 8-bit data, the image data equal to or greater than 256 will overflow), and therefore if the image data overflows, a processing, such as clipping the image data to the maximum value (if image data is 8-bit data, the image data is clipped to 255), may be carried out. In the embodiment, an example with the multiplication coefficient equal to or less than 1 is described.

Next, a procedure for measuring the light amounts L1 and L2 when the currents are I1 and I2 in FIG. 2 is described. The overview of this procedure is as follows. In order to measure the desired light amounts L1 and L2, wait until the image data for feeding the desired currents I1 and I2 comes, and when the desired image data appears, the address location thereof is stored, and the image data is delayed by one frame by the frame memory 3, and then the light amounts L1 and L2 at this address location are measured in the next frame of the frame in which the desired image data appears. Next, the detailed procedure is described.

The digital value of image data for feeding the currents I1 and I2 to the laser 5 can be uniquely determined by the laser driver 4, and the digital value of image data corresponding to the current I1 and the digital value of image data corresponding to the current I2 are stored as R1 and R2, respectively, into a reference value unit 24. In a comparator 25, wait for data D1 and D2, wherein the input image data agrees with the reference values R1 and R2, to come, and a write address when R1=D1 and R1=D2 is stored. If the data D1 or D2 agreeing with R1 or R2 does not come within one frame, then in the next frame, D1 or D2 is similarly compared with R1 or R2. If the D1 or D2 agreeing with R1 or R2 comes, then in the next frame, an enable signal is output to a latch circuit 26 when the address becomes a read address (the same address as the stored write address) corresponding to data D1 or D2. The latch circuit 26 samples and holds the light amounts L1 and L2 from the photosensor 10 when the enable signal is output, and digitally converts these light amounts L1 and L2 and stores the results into the nonvolatile memory 9.

Once the light amounts L1 and L2 are measured, the threshold current (Ith 1) and the slope efficiency (η) are calculated from two points P1 and P2 of FIG. 2 by an η and Ith calculation unit 27. In accordance with the threshold current (Ith1) and slope efficiency (η) calculated by the η and Ith calculation unit 27, a coefficient to the gain circuit 28 and a coefficient to an offset circuit 29 are calculated. The gain circuit 28 multiplies the coefficient equal to or less than 1 to the input image data as described above. The offset circuit 29 does not control the input image data but controls the laser driver 4. The laser driver 4 usually includes a threshold current controller and a gain controller, wherein the threshold current controller controls an offset current value until the laser 5 emits light. The gain controller multiplies a coefficient to the image data as with the gain circuit 28. The offset circuit 29 controls the offset current value of the laser driver 4.

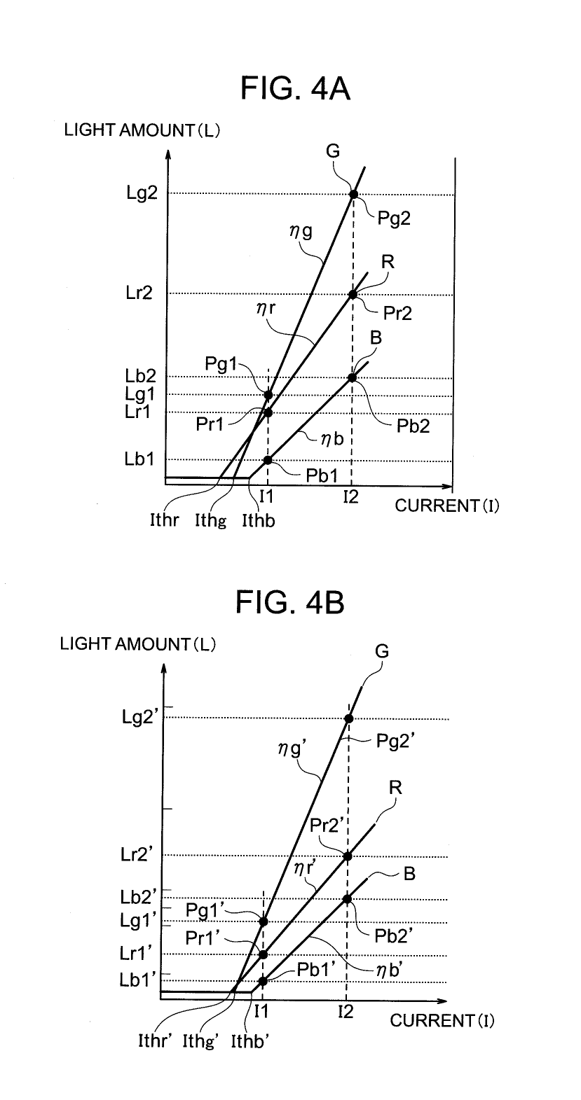

The above is the basic operation of the image processing unit 2. Then, a specific example using the image processing unit 2 and suppressing the variation of the white balance due to the temperature variation is described using FIGS. 4A and 4B, FIG. 5, FIG. 6, and FIG. 7.

FIGS. 4A and 4B each shows a light amount vs. forward current characteristic, wherein FIG. 4A shows the light amount vs. forward current characteristic in an initial state and FIG. 4B shows the light amount vs. forward current characteristic when temperature increases. Moreover, FIGS. 4A and 4B each show the characteristics of three lasers 5 of RGB colors on the same graph. The respective threshold currents of RGB colors in the initial state of FIG. 4A are designated by Ithr, Ithg, and Ithb, the respective light amounts at the current I1 are designated by Lr1, Lg1, and Lb1, and the respective light amounts at the current I2 are designated by Lr2, Lg2, and Lb2, and a slope efficiency ηg is calculated from points Pg1 and Pg2, a slope efficiency ηr from points Pr1 and Pr2, and a slope efficiency ηb from points Pb1 and Pb2. If the white balance is already adjusted at this time, a slope efficiency ratio (ηr:ηg:ηb) in this case corresponds to an RGB ratio of the white balance. Also when the temperature increases as shown in FIG. 4B, similarly, the respective threshold currents of RGB colors are designated by Ithr′, Ithg′, and Ithb′, the respective light amount at the current I1 by Lr1′, Lg1′, and Lb1′, and the respective light amount at the current I2 by Lr2′, Lg2′, and Lb2′, and a slope efficiency ηg′ is calculated from points Pg1′ and Pg2′, and a slope efficiency ηe from points Pr1′ and Pr2′, and a slope efficiency ηb′ from points Pb l′ and Pb2′. Here, when only the slope efficiency ηe varies (decreases) a lot although the slope efficiencies ηg′ and ηb′ scarcely vary as shown in FIG. 4B, a light amount Lr2′ of R decreases a lot as compared with the initial value Lr2 and other light amounts (Lg2′, Lg2′) scarcely vary. Accordingly, the light amount Lr2′ of R decreases, so the white balance is destroyed and the color will change toward cyan. That is, the slope efficiency ratio (ηrηg:ηb) in the initial stage does not agree with a slope efficiency ratio (ηe:ηg:ηb) when temperature increases.

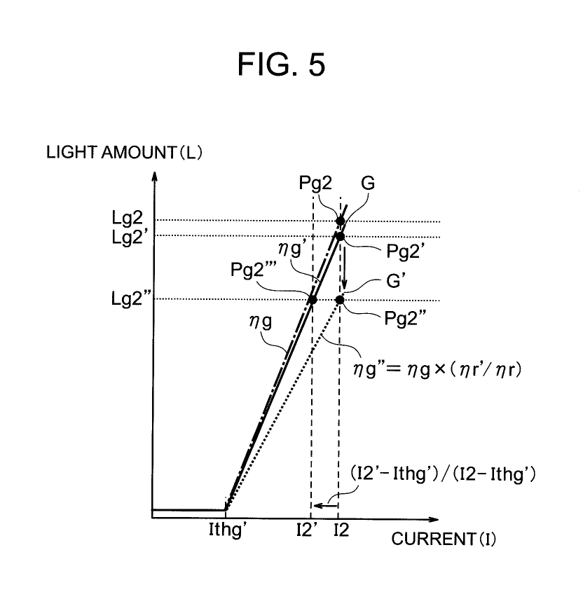

In order to match the white balance when temperature increases with that in the initial state, the ratio ηe:ηg′:ηb′ needs to be adjusted so as to be the same as the ratio ηrηg:ηb. The method therefor is described using FIG. 5. First, the change ratio of the slope efficiency of R having most significantly changed can be defined as ηr′/ηr. Also for other GB colors, the current amount may be adjusted so that their change ratios become the change ratio ηr′/ηr. That is, in the case of an efficiency ηg″ (=ηg×ηr′/ηr) is first calculated by multiplying the slope efficiency ηg of the initial state by the change ratio ηe/ηr. Although this slope efficiency ηg″ is the ideal light amount vs. current characteristic, actually the laser 5 of G exhibits the characteristic of the slope efficiency ηg′ of a solid line (G). Then, the current value needs to be converted. That is, because the light amount vs. current characteristic (dotted-line G′) of the ideal slope efficiency ηg″ exhibits a light amount Lg2″ when the current I2 is fed, a point Pg2′″ is calculated, which indicates a current value I2′ exhibiting the light amount Lg2″ on the light amount vs. current characteristic (dotted line G) after temperature changes. Thus, a ratio (I2′-Ithg′)/(I2-Ithg′) is calculated, and by multiplying this ratio to the desired current value (I) (=I×(I2′-Ithg′)/(I2-Ithg′)), the current value exhibiting the light amount of the ideal light amount vs. current characteristic can be converted. Although the current value (I) is controlled by the laser driver 4, the current value (I) becomes a value proportional to the image data (D) of the image processing unit 2 and thus actually the ratio (I2′-Ithg′)/(I2-Ithg′) will be multiplied in the gain circuit 28 of the image processing unit 2.

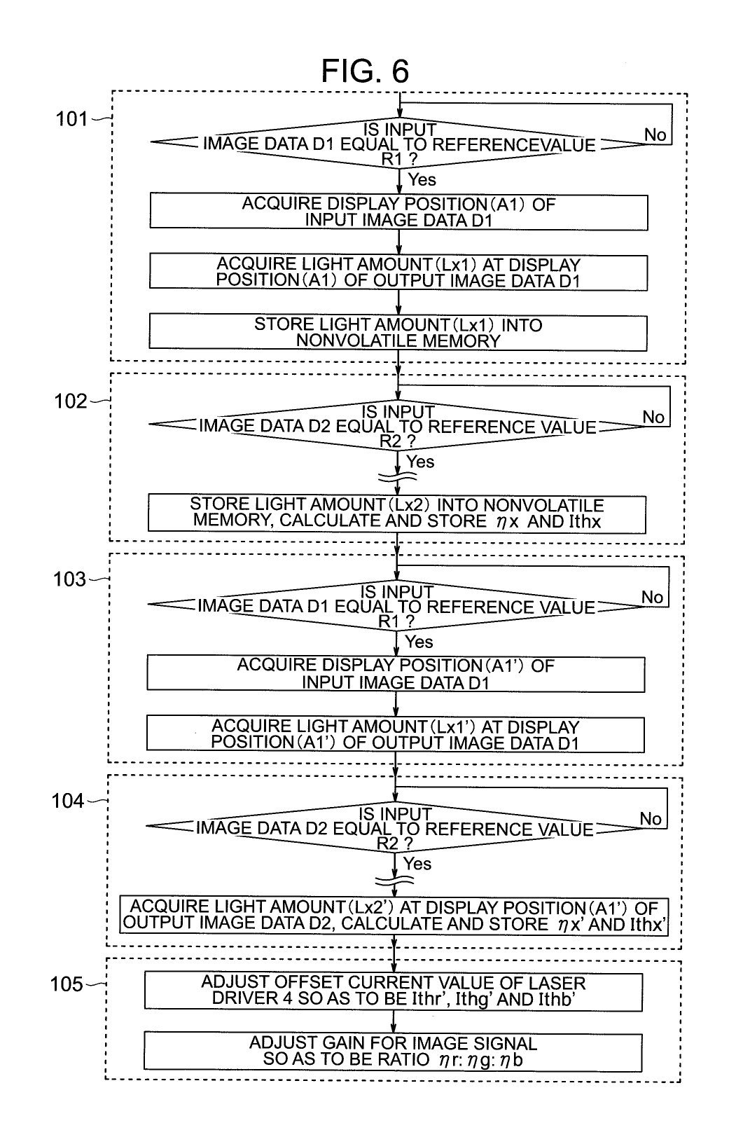

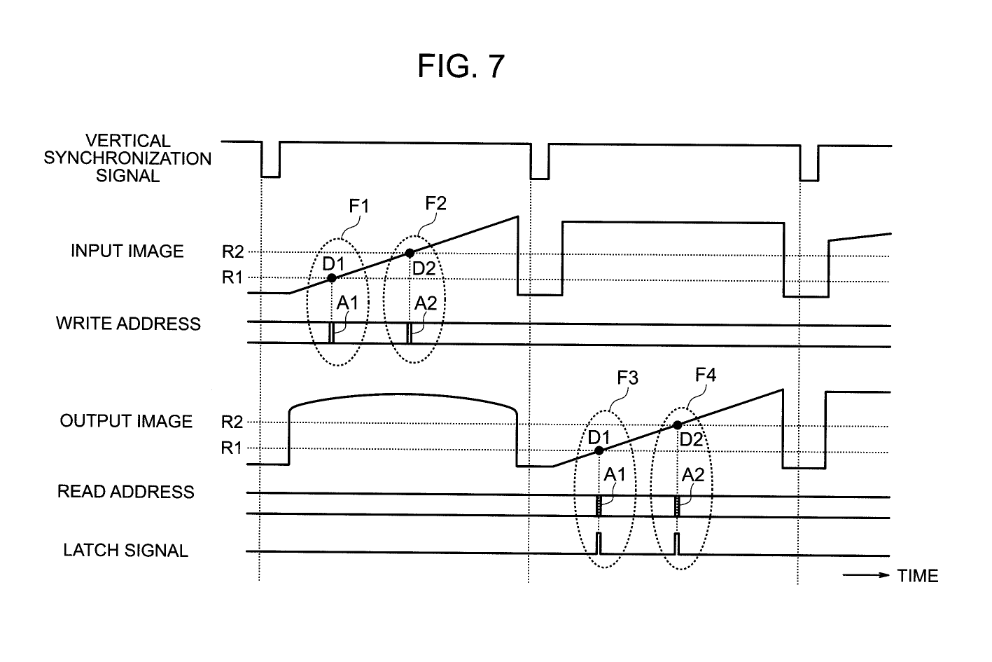

An example of a flow chart when a series of flows of the processing described above is performed by the image processing unit 2 is shown in FIG. 6. As the overview of the flow, in a flow 101 and a flow 102, the various data in an initial state are measured and stored into the nonvolatile memory 9. In a flow 103 and a flow 104, various data when temperature changes are measured and stored into the nonvolatile memory 9. In a flow 105, a correction value is calculated from the various data measured above. Moreover, FIG. 7 is an example of the timing for measuring a light amount. FIG. 7 shows two frames of timings, showing a specific example of input image data, output image data, a write address, a read address, and a latch signal to the latch circuit 26.

Hereinafter, FIG. 6 is described in detail.

(Flow 101) First, in the comparator 25 inside the image processing unit 2, the input image data (D1) is compared with the reference value R1 stored in the reference value unit 24, and the processing is waited until the input image data (D1) agreeing with the reference value R1 is input. If the input image data (D1) agreeing with the reference value R1 is input, then a write address (A1) of the frame memory 3, which is a display position at this time, is acquired (corresponding to F1 of FIG. 7). At the read address (A1) of the frame memory 3 that is a display position of the output image data (D1) in the next frame, an enable signal is output to the latch circuit 26 (corresponding to F3 of FIG. 7). The latch circuit 26 acquires light amount data (Lx1) of the photosensor 10 at the timing of this enable signal, and stores the light amount data (Lx1) into the nonvolatile memory 9. This light amount data (Lx1) is the reference value for correction. Note that, x of the light amount data (Lx1) denotes each Lr1, Lg1, and Lb1 of RGB colors, and for the above-described input image data (D1) and reference value R1, the data is separately processed for each of RGB colors. If the photosensor 10 is a sensor of a type containing RGB color filters and being capable of simultaneously acquiring the light amounts of RGB colors, the input image data (D1) causes no problem even if RGB come at a simultaneous timing. However, if the photosensor 10 is a sensor of a type not containing the RGB color filters, the input image data (D1) needs to be compared for each of RGB colors at different timings.

(Flow 102) In the comparator 25, input image data (D2) is compared with a reference value R2 stored in the reference value unit 24, and the processing is waited until the input image data (D2) agreeing with the reference value R2 is input. If the input image data (D2) agreeing with the reference value R2 is input, then a write address (A2) of the frame memory 3, which is a display position at this time point, is acquired (corresponding to F2 of FIG. 7). At the read address (A2) of the frame memory 3, which is a display position of the output image data (D2) in the next frame, an enable signal is output to the latch circuit 26 (corresponding to F4 of FIG. 7). The latch circuit 26 acquires light amount data (Lx2) of the photosensor 10 at the timing of this enable signal, and stores the light amount data (Lx2) into the nonvolatile memory 9. Note that, since there is a relation D1<D2, a relation Lx1<Lx2 is established. In the η and Ith calculation unit 27, points Px1 and Px2 are determined from Lx1 and Lx2, a straight line is approximated from the points Px1 and Px2, and a slope efficiency ηx and a threshold current Ithx of this approximation straight line are calculated and stored into the nonvolatile memory 9. The slope efficiency ηx and the threshold current Ithx are the reference values for correction. Similarly, x of ηx and Ithx denotes either of RGB colors.

(Flow 103) When the light amount vs. current characteristic of the laser 4 varies with temperature change, in the comparator 25, the input image data (D1) is compared with the reference value R1 stored in the reference value unit 24, and the processing is waited until the input image data (D1) agreeing with the reference value R1 is input. If the input image data (D1) agreeing with the reference value R1 is input, then a write address (A1′) of the frame memory 3 that is a display position at this time point is acquired. At the read address (A1′) of the frame memory 3, which is a display position of the output image data (D1) in the next frame, an enable signal is output to the latch circuit 26. The latch circuit 26 acquires light amount data (Lx1′) of the photosensor 10 at the timing of this enable signal, and stores the light amount data (Lx1′) into the nonvolatile memory 9.

(Flow 104) In the comparator 25, input image data (D2) is compared with a reference value R2 stored in the reference value unit 24, and the processing is waited until the input image data (D2) agreeing with the reference value R2 is input. If the input image data (D2) agreeing with the reference value R2 is input, then a write address (A2′) of the frame memory 3 that is a display position at this time point is acquired. At the read address (A2′) of the frame memory 3, which is a display position of the output image data (D2) in the next frame, an enable signal is output to the latch circuit 26. The latch circuit 26 acquires light amount data (Lx2′) of the photosensor 10 at the timing of this enable signal, and stores the light amount data (Lx2′) into the nonvolatile memory 9. In the η and Ith calculation unit 27, the points Px1′ and Px2′ are determined from Lx1′ and Lx2′, a straight line is approximated from the Px1′ and Px2′, and the slope efficiency ηx′ and threshold current Ithx′ of this approximation straight lines are calculated and stored into he nonvolatile memory 9.

(Flow 105) The offset circuit 29 controls and adjusts the laser driver 4 so that the threshold currents become Ithr′, Ithg′, and Ithb′, respectively. Moreover, the η and Ith calculation unit 27 determines, among the slope efficiencies ηr′, ηg′ and ηb′, a slop efficiency that has most significantly varied from the reference values ηr, ηg, and ηb. For example, when ηr′ has the largest variation, the change rate ηr′/ηr is calculated, ηg″ (=ηg×ηr′/ηr) and ηb″ (=ηb×ηr′/ηr) are calculated and further I2g′ and I2b′ (corresponding to I2′ in FIG. 5) are calculated, and coefficients (I2g′-Ithg′)/(12-Ithb′) and (I2b′-Ithb′)/(I2-Ithb′) are calculated. The η and Ith calculation unit 27 supplies the coefficients to the gain circuit 28.

With the above-described operations, correction can be made without changing the white balance even when temperature changes.

Note that, in the present invention, the light amount vs. current characteristic is approximated with a straight line, but not limited thereto, and the approximation line may be a nonlinear curve such as a polynomial.

### Embodiment 2

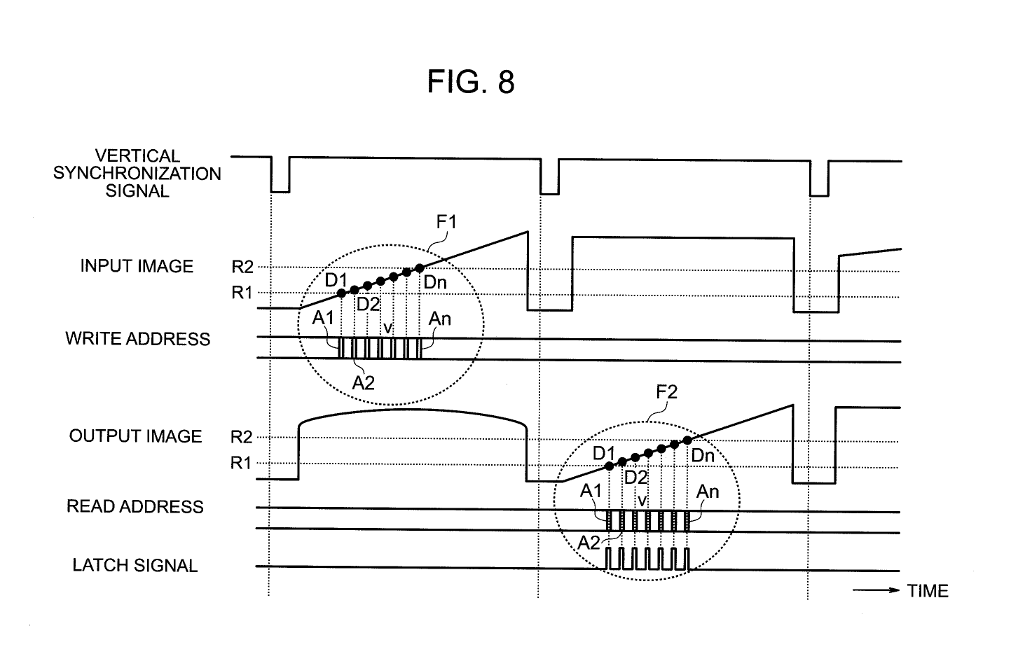

Next, Embodiment 2 in the present invention is described. FIG. 8 is a view showing an operation example of the embodiment. The difference from Embodiment 1 is the method of setting the reference value stored in the reference value unit 24, and other than this is the same as Embodiment 1, so the detailed description thereof is omitted.

In Embodiment 1, the reference values stored in the reference value unit 24 are two points R1 and R2. When there are only two reference value, input image data (D1, D2) equal to these reference values may not frequently appear, and the timing at which correction can be made may be limited. Then, in Embodiment 2, all the input image data that fall in between the reference values R1 and R2 shall be utilized. That is, all the write addresses A1 to An corresponding to the input image data D1 to Dn (n is an integer) that fall in between the reference values R1 and R2, as indicated by F1 of FIG. 8, are acquired. At the read addresses (A1 to An) of the frame memory 3 that are display positions of the output image data (D1 to Dn) in the next frame, an enable signal is output to the latch circuit 26 (corresponding to F2 of FIG. 8). The latch circuit 26 acquires light amount data (Lx1 to Lxn) of the photosensor 10 at the timing of this enable signal, and stores the light amount data (Lx1 to Lxn) into the nonvolatile memory 9. Furthermore, the η and Ith calculation unit 27 determines the points Px1-Pxn from Lx1-Lxn, and carries out straight-line approximation using these points. Because operations other than this are the same as Embodiment 1, the detailed description thereof is omitted.

Note that, the reference value R1 may be set to the minimum value (0 in the case of 8 bits) of the digital value, and R2 may be set to the maximum value (255 in the case of 8 bits) of the digital value, and in this case, all the input image data will be captured. However, the capacity of the nonvolatile memory 9 may run out, so the number of data to capture may be adjusted in accordance with the capacity of the nonvolatile memory 9.

### Embodiment 3

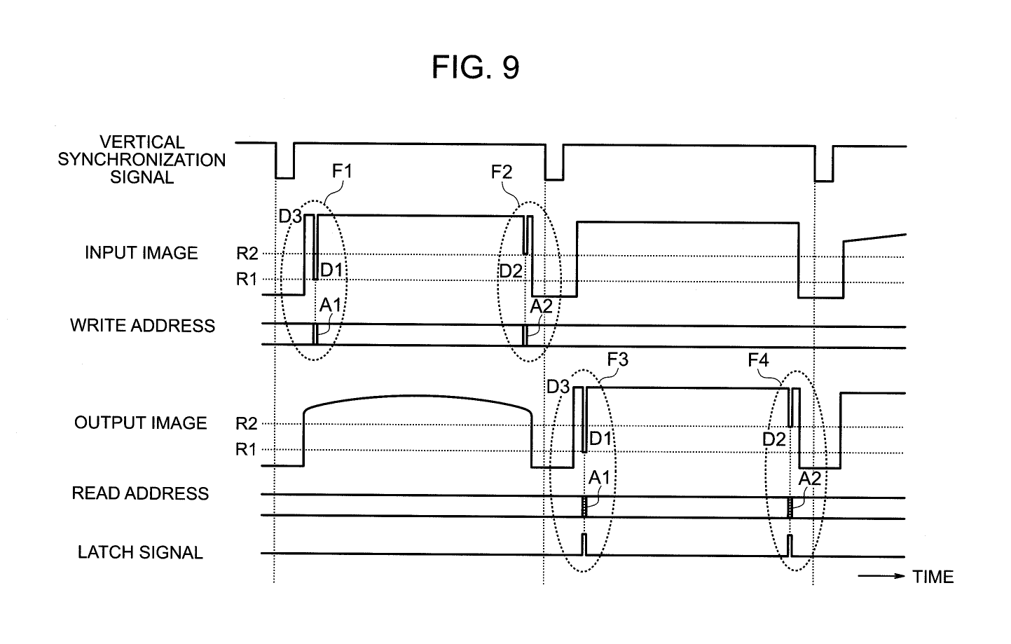

Next, Embodiment 3 in the present invention is described. FIG. 9 is a view showing an operation example of the embodiment. A difference from Embodiment 1 and Embodiment 2 is a scheme, wherein assuming cases where image data will not fall in a range of the reference values stored in the reference value unit 24, a value is actively superimposed on the image data so that the image data thus superimposed falls in a range of the reference values of the reference value unit 24 (or the image data may be actively replaced by a value serving as a reference value). Because other than this scheme is the same as the Embodiment 1 and Embodiment 2, the detailed description thereof is omitted. In Embodiment 2, the range of the reference values in the reference value unit 24 is between R1 to R2. Input image data may not frequently fall in between these reference values R1 and R2, and thus the timing at which correction can be made may be limited. Then, in the Embodiment 3, if a reference value does not fall in between R1 and R2 for a predetermined period, two input image data are temporarily superimposed on the input image data D3 so that the image data D3 thus superimposed becomes D1 and D2 corresponding to the reference values R1 and R2, that is, falls in a range of the reference values of the reference value unit 24. Alternatively, if a reference value does not fall in between R1 and R2 for a predetermined period, the input image data D3 may be temporarily replaced by the input image data D1 and D2 corresponding to the reference values R1 and R2. In this embodiment, the replacement method is employed in place of the superimposing method. That is, the input image data D3 is temporarily replaced by the input image data D1 and D2 corresponding to the reference values R1 and R2 as indicated by F1 and F2 of FIG. 9, and the write addresses thereof. A1 and A2 are acquired. At the read addresses (A1 and A2) of the frame memory 3, which are display positions of the replaced input image data D1, D2 in the next frame, enable signals are output to the latch circuit 26 (F3, F4 of FIG. 9). The latch circuit 26 acquires the light amount data (Lx1, Lx2) of the photosensor 10 at the timings of this enable signals, and stores the light amount data (Lx1, Lx2) into the nonvolatile memory 9. Furthermore, the η and Ith calculation unit 27 determines the points Px1 and Px2 from the light amount data Lx 1 and Lx2, and carries out straight-line approximation using these points. Because operations other than this are the same as the Embodiment 1 and Embodiment 2, the detailed description thereof is omitted.

Note that, in the case where the input image data D3 is temporarily replaced by the input image data D1 and D2 corresponding to the reference values R1 and R2, if this replacement continues over several frames, these image data D1 and D2 can be visually inspected. Therefore, in the case where the input image data D3 is temporarily replaced by the input image data D1 and D2, it is preferable that the replacement is performed only for one frame period and that the replacement of the input image data D1 and D2 will not be preformed in the subsequent frames for a while. Thus, even if the replacement of the input image data D1 and D2 is preformed, this is performed only in one frame. Therefore, the image data replaced by these image data D1 and D2 can be suppressed to a level that it cannot be visually inspected. Moreover, the level of the original input image data D3 is also preferably equal to or greater than R2 level. This is because when the original input image data is equal to or less than R1, the input image data results in an extremely dark image and thus if the input image data is replaced by the bright image data D1 and D2 in the dark image, this replaced image data might be visually inspected. Moreover, when the replacement is performed as shown in FIG. 9, the replacements of the image data D1 and D2 are preferably performed on peripheral portions as close as possible, not on the center portion of a screen. This is because the likelihood of being visually inspected decreases.

Moreover, in the Embodiment 1 and Embodiment 2, it is determined whether or not input image data corresponds to the reference value, while in the case of the Embodiment 3, the determination of the input image data may be eliminated and the replacement of the image data D1 and D2 may be forcedly performed at a predetermined cycle. The cycle of the replacement in this case is preferably as long as possible. For example, the cycle is equal to or longer than one second.

Moreover, FIG. 9 shows an example of performing the replacement of the image data D1 and D2 in one frame, but not limited thereto, and the replacement of only the image data D1 may be performed in one frame, and subsequently after one second or more, the replacement of only the image data D2 may be performed to thereby acquire the light amount data (Lx1, Lx2) whereby the likelihood of being visually inspected can be reduced.

### Embodiment 4

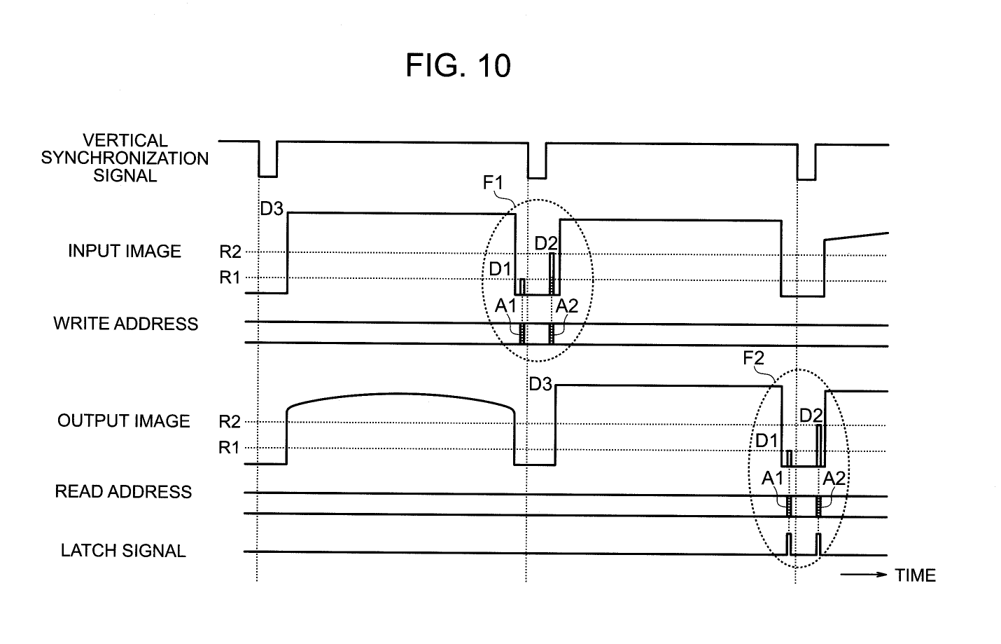

Next, Embodiment 4 in the present invention is described. FIG. 10 is a view showing an operation example of this embodiment. A difference from the Embodiment 1 and Embodiment 2 is a scheme, wherein assuming cases where image data will not fall in a range of the reference values in the reference value unit 24, the replacement of image date corresponding to the reference values is actively performed, and also the locations where the replacement of the image date corresponding to the reference values is performed differ from the Embodiment 3. Because other than these points is the same as the Embodiment 3, the detailed description thereof is omitted.

In the Embodiment 3, if the image data does not fall in between R1 and R2 for a predetermined period, the input image data D3 is temporarily replaced by the image data D1 and D2 corresponding to the reference values, wherein this replacement takes place in an image display area. In this Embodiment 4, the input image data D3 is temporarily replaced by the image data D1 and D2 corresponding to the reference values during the blanking period of an image. That is, the input image data D3 is temporarily replaced by the image data D1 and D2 corresponding to the reference values R1 and R2 during the blanking period of an image as indicated by F1 of FIG. 10, and the write addresses thereof. A1 and A2 are acquired. At the read addresses (A1 and A2) of the frame memory 3, which are display positions of the D1 and D2 replaced during the blanking period of the output image data in the next frame, enable signals are output to the latch circuit 26 (F2 of FIG. 10). The latch circuit 26 acquires the light amount data (Lx1, Lx2) of the photosensor 10 at the timings of the enable signals, and stores the light amount data (Lx1, Lx2) into the nonvolatile memory 9. Furthermore, the n and Ith calculation unit 27 determines the points Px1 and Px2 from Lx1 and Lx2, and carries out straight-line approximation using these points. Because the other operation is the same as the Embodiment 1 or Embodiment 3, the detailed description thereof is omitted.

Note that, in the case where the replacement of the image data D1 and D2 is performed during the blanking period of an image, if this replacement continues over several frames, the image data with these D1 and D2 can be visually inspected. Therefore, when the replacement of the image data D1 and D2 is performed, it is preferable that the replacement is performed only for one frame period and that the replacement of the image data D1 and D2 will not be performed in the subsequent frames for a while. Thus, even if the replacement of the image data D1 and D2 is performed, this is performed only in one frame. Therefore, the replacement of the image data D1 and D2 can be suppressed to a level at which it cannot be visually inspected. Moreover, the level D3 of the input image data immediately before the blanking period of an image to be replaced is also preferably a level equal to or greater than R2. This is because when the original input image data is equal to or less than R1, the input image data results in an extremely dark image and thus if the bright image data D1 and D2 are returned or blanked into this dark image, this might be visually inspected. Moreover, when replaced as shown FIG. 10, the replacement of the image data D1 and D2 is preferably performed on a peripheral portion of a screen as close as possible, not in the center portion during the blanking period. This is because the likelihood of being visually inspected decreases.

Moreover, in the Embodiment 1 and Embodiment 2, it is determined whether or not input image data is image data corresponding to the reference values, but as with the Embodiment 3, the determination of the reference values may be eliminated and the replacement of the reference values D1 and D2 may be forced to be performed during the blanking period at a predetermined cycle. The cycle of the replacement in this case is preferably as long as possible. For example, the cycle is equal to or longer than one second.

Moreover, FIG. 10 shows an example of replacing the reference values D1 and D2 during the blanking period of one frame, but not limited thereto, and the replacement of only the image data D1 corresponding to the reference value R1 may be performed during the blanking period of one frame, and subsequently after one second or more, the replacement of only the image data D2 corresponding to the reference value R2 may be performed during a blanking period to acquire the light amount data (Lx1, Lx2) whereby the likelihood of being visually inspected can be reduced.

In each of the embodiment 3 and embodiment 4, in place of the replacement of the image data D1 and D2 corresponding to the reference values R1 and R2, the image data D1 and D2 corresponding to the reference values R1 and R2 may be temporarily superimposed on the input image data D3 so that the image data D3 thus superimposed falls in a range of the reference values of the reference value unit 24.

That is, in the aforesaid embodiment 3, two input image data may be temporarily superimposed on the input image data D3 so that the image data D3 thus superimposed becomes D1 and D2 corresponding to the reference values R1 and R2, that is, falls in a range of the reference values of the reference value unit 24. Alternatively, only the reference value D1 may be superimposed in one frame, and subsequently after one second or more, only the reference value D2 may be superimposed to acquire the light amount data (Lx1, Lx2) whereby the likelihood of being visually inspected can be reduced.

In the aforesaid embodiment 4, the input image data D1 and D2 corresponding to the reference values R1 and R2 may be temporarily superimposed on the input image data during the blanking period. Alternatively, only the reference value D1 may be superimposed during the blanking period of one frame, and subsequently after one second or more, only the reference value D2 may be superimposed during a blanking period to acquire the light amount data (Lx1, Lx2) whereby the likelihood of being visually inspected can be reduced.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus which projects and displays an image by scanning emitted light from a plurality of light sources by means of a reflective mirror, comprising:
the plurality of light sources;
a light source drive unit configured to drive the plurality of light sources;
the reflective mirror that reflects emitted light from the light sources and projects the reflected light onto an object;
a mirror driving unit configured to drive the reflective mirror;
an image processing unit configured to perform signal processing on an input image signal;
a sensor which measures a light amount of each of the plurality of light sources; and
a correction unit configured to:
set a first reference signal level and a second reference signal level;
calculate a threshold value and a slope efficiency of a light amount vs. current characteristic of each of the plurality of light sources, from a first light amount value obtained by measuring a light amount when the input image signal agrees with the first reference signal level by means of the sensor and a second light amount value obtained by measuring a light amount when the input image signal agrees with the second reference signal level by means of the sensor;
store initial values of the threshold value and the slope efficiency; and
correct, when a calculation result of the threshold value and the slope efficiency varied after a predetermined time, a threshold current and also make a correction so that a light amount ratio of the plurality of light sources becomes the same as an initial value of a slope efficiency ratio.

2. The image display apparatus of claim 1, wherein the correction unit linearly approximates the light amount vs. current characteristic from the first light amount value and the second light amount value, sets a contact between the approximation straight line and a light amount axis of the light amount vs. current characteristic to a threshold value, and calculates so as to set a gradient of the approximation straight line to a slope efficiency.

3. The image display apparatus of claim 1, wherein the correction unit controls the light source drive unit so that the threshold value of the light amount vs. current characteristic agrees with a varied threshold current.

4. The image display apparatus of claim 1, wherein when the slope efficiency of the plurality of light sources varied from an initial value, and when in the slope efficiency of a light source having the largest variation, the initial value of the slope efficiency of this light source is designated by η1, the slope efficiency after this light source varied is designated by η2, and the initial value of the slope efficiency of another light source is designated by η3, the correction unit controls a current of the another light source so that the slope efficiency of the another light source is equal to η3×η2/η1.

5. The image display apparatus of claim 1, wherein when a period, during which an input image signal does not agree with the first reference signal level or the second reference signal level, continues for a predetermined time or more, the correction unit replaces temporarily the input image signal by an image of the first reference signal level or the second reference signal level in the input image signal, and measures a light amount thereof by means of the sensor.

6. The image display apparatus of claim 1, wherein when a period, during which an input image signal does not agree with the first reference signal level or the second reference signal level, continues for a predetermined time or more, the correction unit replaces temporarily the input image signal by an image of the first reference signal level or the second reference signal level during a vertical blanking period of the input image signal and measures a light amount thereof by means of the sensor.

7. The image display apparatus of claim 1, wherein when a period, during which an input image signal does not agree with the first reference signal level or the second reference signal level, continues for a predetermined time or more, the correction unit superimposes an image of the first reference signal level or the second reference signal level into the input image signal, and measures a light amount thereof by means of the sensor.

8. The image display apparatus of claim 1, wherein when a period, during which an input image signal does not agree with the first reference signal level or the second reference signal level, continues for a predetermined time or more, the correction unit superimposes an image of the first reference signal level or the second reference signal level during a vertical blanking period of the input image signal and measures a light amount thereof by means of the sensor.

9. The image display apparatus of claim 5, wherein the period, during which an input image signal does not agree with the first reference signal level or the second reference signal level, is set to one second or more.

10. The image display apparatus of claim 6, wherein the period, during which an input image signal does not agree with the first reference signal level or the second reference signal level, is set to one second or more.

11. An image display apparatus which projects and displays an image by scanning emitted light from a plurality of light sources by means of a reflective mirror, comprising:
the plurality of light sources;
a light source drive unit configured to drive the plurality of light sources;
the reflective mirror that reflects emitted light from the light sources and projects the reflected light onto an object;
a mirror driving unit configured to drive the reflective mirror;
an image processing unit configured to perform signal processing on an input image signal;
a sensor which measures a light amount of each of the plurality of light sources; and
a correction unit configured to:
set a first reference signal level and a second reference signal level;
calculate a threshold value and a slope efficiency of a light amount vs. current characteristic of each of the plurality of light sources, from a plurality of light amount values obtained by measuring a light amount when a level of the input image signal agrees with a level in a range from the first reference signal level to the second reference signal level by means of the sensor,
store initial values of the threshold value and the slope efficiency; and
correct, when a calculation result of the threshold value and the slope efficiency varied after a predetermined time, a threshold current and also make a correction so that a light amount ratio of the plurality of light sources becomes the same as an initial value of a slope efficiency ratio.

12. The image display apparatus of claim 11, wherein the correction unit linearly approximates the light amount vs. current characteristic from the plurality of light amount values, sets a contact between the approximation straight line and a light amount axis of the light amount vs. current characteristic to a threshold value, and calculates so as to set a gradient of the approximation straight line to a slope efficiency.

13. The image display apparatus of claim 11, wherein the correction unit controls the light source drive unit so that the threshold value of the light amount vs. current characteristic agrees with a varied threshold current.

14. The image display apparatus of claim 11, wherein when the slope efficiency of the plurality of light sources varied from an initial value, and when in the slope efficiency of a light source having the largest variation, the initial value of the slope efficiency of this light source is designated by η1, the slope efficiency after this light source varied is designated by η2, and the initial value of the slope efficiency of another light source is designated by η3, the correction unit controls a current of the another light source so that the slope efficiency of the another light source is equal to η3×η2/η1.

15. The image display apparatus of claim 11, wherein when a period, during which an input image signal does not agree with a range from the first reference signal level to the second reference signal level, continues for a predetermined time or more, the correction unit replaces temporarily the input image signal by the first reference signal level or the second reference signal level in the input image signal and measures a light amount thereof by means of the sensor.

16. The image display apparatus of claim 11, wherein when a period, during which an input image signal does not agree with a range from the first reference signal level to the second reference signal level, continues for a predetermined time or more, the correction unit replaces temporarily the input image signal by the first reference signal level or the second reference signal level during a vertical blanking period of the input image signal and measures a light amount thereof by means of the sensor.

17. The image display apparatus of claim 11, wherein when a period, during which an input image signal does not agree with a range from the first reference signal level to the second reference signal level, continues for a predetermined time or more, the correction unit superimposes an image of the first reference signal level or the second reference signal level into the input image signal and measures a light amount thereof by means of the sensor.

18. The image display apparatus of claim 11, wherein when a period, during which an input image signal does not agree with a range from the first reference signal level to the second reference signal level, continues for a predetermined time or more, the correction unit superimposes an image of the first reference signal level or the second reference signal level during a vertical blanking period of the input image signal and measures a light amount thereof by means of the sensor.

19. The image display apparatus of claim 15, wherein the period, during which an input image signal does not agree with the first reference signal level or the second reference signal level, is set to one second or more.

20. The image display apparatus of claim 16, wherein the period, during which an input image signal does not agree with the first reference signal level or the second reference signal level, is set to one second or more.
